(19) United States
(12) Patent Application Publication
(10) Pub. No.: US 2004/0103125 A1
(43) Pub. Date: May 27, 2004

(54) Group submission of edits for rules checking

(75) Inventor: David J. Kasper II, Aliso Viejo, CA (US)

Correspondence Address: Fogg and Associates, LLC, P.O. Box 581339, Minneapolis, MN, 55458-1339, US

(73) Assignee: ADC DSL Systems, Inc.

(21) Appl. No.: 10/316,346

(22) Filed: Dec. 11, 2002

Related U.S. Application Data
(63) Continuation-in-part of application No. 10/303,138, filed on Nov. 21, 2002.
(63) Continuation-in-part of application No. 10/303,091, filed on Nov. 21, 2002.

(51) Int. Cl. G06F 17/30; G06F 12/00

(52) U.S. Cl. 707/203

(57) ABSTRACT

A set of edits to data stored in a first database are stored in a second database before submission for rules checking and, if appropriate, storage in the first database. The set of edits are submitted for rules checking as a group.

### RELATED APPLICATIONS

The present application is a Continuation-In-Part (CIP) of the following co-pending U.S. Patent applications incorporated herein by reference as if fully set forth: application Ser. No. 10/303,138, filed on Nov. 21, 2002, Attorney Docket No. 100.482US01, titled “CHANGE DETECTION IN A GRAPHICAL USER INTERFACE” and application Ser. No. 10/303,091, filed on Nov. 21, 2002, Attorney Docket No. 100.483US01, titled “MESSAGE PASSING IN A GRAPHICAL USER INTERFACE.”

### TECHNICAL FIELD

The following description relates in general to databases and more particularly to editing data stored in a database.

### BACKGROUND

Software-based systems typically include some type of user interface for human-computer interaction by which a system obtains input from users and provides output. A user may provide such input via an input device such as a keyboard and/or a mouse that is attached to, or is in communication with, the system. The system may display output on an output device such as a computer monitor that is attached to, or is in communication with, the system.

One type of user interface is a graphical user interface (“GUI”). A GUI typically uses menus and/or other user interface controls to obtain input from the user and windows and/or screens to display information for the user. A window (or other GUI element such as a screen) is typically constructed from one or more visual components such as text fields, images, scroll bars, and the like. The window is displayed by drawing each component of the window on the display. Typically, this involves drawing the visible portions of each component. A portion of a component may not be visible, for example, because that portion has scrolled out of the window or has otherwise been hidden from view. The components can be created using, for example, text or bitmapped images. Examples of GUIs may be found in the WINDOWS operating systems, available from Microsoft Corporation.

One application for a graphical user interface is in embedded systems. For example, a high-speed digital subscriber line 2 (HDSL2) line interface card typically includes an embedded control program that may be accessed by a GUI. The GUI enables a user to view and/or change various operating parameters for the line interface card and to monitor system performance. In some implementations, the line card includes a craft port (for example, a RS-232 serial port) to which a user physically connects a portable computer or other device to communicate with the embedded control program. In some other implementations, the embedded control program and the user may communicate via an embedded operations channel included in the main HDSL2 data link provided by the line interface card.

### SUMMARY

In general, in one aspect, a method of processing edits to one or more of a plurality of items stored in a first database includes receiving input and, when the input indicates that an edit has been made to one of the plurality of items, storing the edited item in a second database. The second database stores a set of edited items. The method further includes, when the input indicates that the set of edited items should be stored in the first database, retrieving the set of edited items from the second database and submitting the set of edited items for rules checking as a group.

In general, in another aspect, a program includes a storage medium tangibly embodying program instructions for processing edits to one or more of a plurality of items stored in a first database. The program instructions include instructions operable to cause at least one programmable processor to receive input, and, when the input indicates that an edit has been made to one of the plurality of items, store the edited item in a second database. The second database stores a set of edited items. The program instructions further include instructions operable to cause the programmable processor to, when the input indicates that the set of edited items should be stored in the first database, retrieve the set of edited items from the second database and submit the set of edited items for rules checking as a group.

In general, in another aspect, a telecommunication device includes a first interface adapted to couple the telecommunications device to a user input device. The telecommunication device further includes a controller coupled to the first interface. The controller is adapted to receive input from the input device and, when the input indicates that an edit has been made to one of the plurality of items, store the edited item in a second database. The second database stores a set of edited items. The controller is further adapted to, when the input indicates that the set of edited items should be stored in the first database, retrieve the set of edited items from the second database and submit the set of edited items for rules checking as a group.

In general, in another aspect, a method of refreshing an item displayed in a user interface includes determining when the item has been edited. The method further includes, when the item has not been edited, displaying the value for the item stored in the first database, and, when the item has been edited, displaying the edited value for the item stored in a second database.

In general, in another aspect, a program includes a storage medium tangibly embodying program instructions for refreshing an item displayed in a user interface. The program instructions include instructions operable to cause at least one programmable processor to determine when the item has been edited. The program instructions further include instructions operable to cause the programmable process to, when the item has not been edited, display the value for the item stored in a first database, and, when the item has been edited, display the edited value for the item stored in a second database.

In general, in another aspect, a telecommunication device includes a first interface adapted to couple the telecommunications device to an output device. The telecommunication device further includes a controller, coupled to the first interface, that is adapted to determine when an item displayed in a user interface on the output device has been edited. The controller is further adapted to, when the item has not been edited, display in the user interface on the output device the value for the item stored in a first database, and, when the item has been edited, display in the user interface on the output device the edited value for the item stored in a second database.

### DRAWINGS

FIG. 1 is a block diagram of one embodiment of a system that uses a secondary database to process edits.

FIG. 2 is flow diagram of one embodiment of a method of processing edits using secondary database.

FIG. 3 is one embodiment of a method of refreshing an item of system data displayed in a user interface.

FIG. 4 is a block diagram of one embodiment of an HDSL line interface unit.

### DETAILED DESCRIPTION

In the following detailed description, reference is made to the accompanying drawings that form a part hereof, and in which are shown by way of illustration specific embodiments in which the invention, as claimed, may be practiced. It is to be understood that other embodiments may be utilized and structural changes may be made without departing from the scope of the claimed invention.

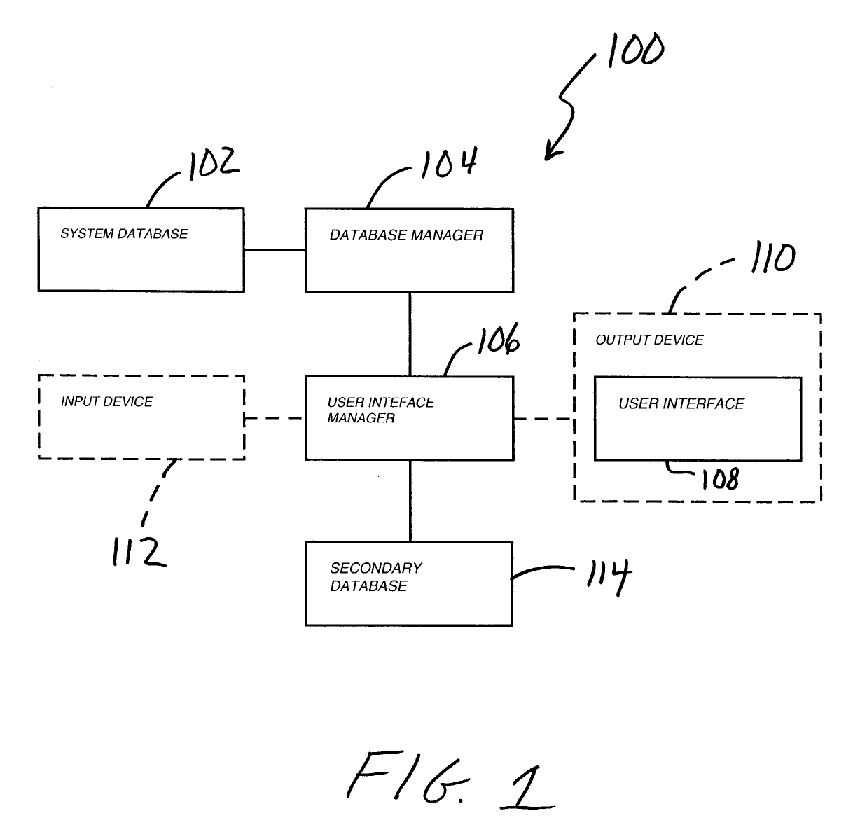

FIG. 1 is a block diagram of one embodiment of a system 100 that includes a system database 102, a database manager 104 and a user interface manager 106. System database 102 stores data that is related to the system 100 (or a system in communication with system 100). In one embodiment, system data includes data related to configuration and performance of one or more processes monitored or controlled by system 100, or another system in communication with system 100. In such an embodiment, the system database 102 includes several items such as records and/or other database objects in which system data is stored. System data is input to, and retrieved from, the system database 102 by the database manager 104. Database manager 104 maintains the system data stored in system database 102 and communicates with processes and devices that provide data for storage in the system database 102 and that retrieve system data from the system database 102. In one implementation of such an embodiment, system database 102 includes an object-oriented database in which several database objects are stored. System data, in such an implementation, is stored within one or more of the database objects. In other embodiments, system database 102 is implemented using additional or alternate data storage structures. For example, in other embodiments, system database 102 is implemented using a hierarchical or relational database or one or more flat files. Moreover, in one embodiment, system database 102 is implemented as a part of a single, centralized database. In other embodiments, system database 102 is implemented as a part of a distributed data storage scheme using one or more databases.

User interface manager 106 includes one or more processes that generate and display user interface 108 on an output device 110 in communication with the user interface manager 106. User interface 108 is generated and displayed by creating and displaying one or more user interface components such as a field, window, screen, and/or the like. System data is displayed in the user interface 108 for a user to view and edit. The user interface 108 is typically dynamic and changes in response to, for example, input received from the user and changes to related system data stored in the system database 102. User interface manager 106 receives input from an input device 112 that is in communication with the user interface manager 106. The input includes, for examples, user interface events such as mouse movements, mouse clicks, or keystrokes. Some of the input received by the user interface manager 106 causes the user interface manager 106 to navigate through the various user interface components included in user interface 108 (for example, by moving a cursor from one field included in the user interface 108 to a second field included in the user interface 108). Another type of input received by user interface manager 106 is data that is to be stored in the system database 102. The latter type of input is provided by the user, for example, by entering such data in a field or other user interface component or by changing data that is already displayed in the user interface 108.

In one embodiment, for example, user interface manager 106 generates user interface 108 by retrieving system data stored in the system database 102. The user interface manager 106 retrieves the system data by requesting the system data from the database manager 104. The database manager 104 retrieves the system data from the system database 102 and passes the system data to the user interface manager 106. User interface manager 106, in such an embodiment, uses the retrieved system data to display user interface 108 on the output device 110 in communication with the system 100. User interface 108 includes one or more user interface components (such as fields, windows, or screens). At least a portion of the received system data is displayed by the user interface manager 106 in one or more fields (or other user interface components) included in the user interface 108. Some of the fields allow the user to enter data (if data is not displayed in the field) or change any data displayed in the field (collectively referred here as “editing” or making “edits”). For example, in such an embodiment, the user moves a cursor to such a field (or otherwise makes the field the focus of the user's input). The user can move the cursor, for example, by pressing one or more arrow keys on the input device 112 (such as a keyboard) that is in communication with the user interface manager 106. Then, the user makes edits to that field, for example, by entering various conventional editing keystrokes.

As noted above, as a part of maintaining the system database 102, database manager 104 retrieves system data stored in the system database 102 for other processes (such as user interface 106). Database manager 104 also updates the system data stored in the system database 102 based on data received from such other processes. Database manager 104, as a part of the process of updating the system data stored in the system database 102, checks if a proposed update satisfies any rules associated with the item of system data to be updated. If all of the rules associated with the item are satisfied, the database manager 104 performs the proposed update to the item. If any rule associated with the item is not satisfied, the database manager 104 does not perform the proposed update and, for example, an error is signaled (for example, by displaying an error message in the user interface 108). One example of a proposed update occurs when the user interface manager 106 receives an edit to system data displayed in the user interface 108. The edit is a proposed update to the item of system data that has been edited and is also referred to here as a “proposed edit.” The user interface manager 106 sends the proposed edit to the database manager 104. The database manager 104 checks if the proposed edit satisfies any rules associated with the system data that is to be updated by the proposed edit. If any such rules are satisfied, the system data stored in the system database 102 is updated in accordance as specified by the proposed edit.

Rules are functions of one or more items of system data stored in the system database 102. When a rule is applied to a proposed update, for any item of system data that would be changed by the proposed update, the value that is used in the rules checking process for that item is the value that item would have after the proposed update was applied to that item. For any item used in the rules check processing that would not be affected by the proposed update, the value stored in the system database 102 at the time the rule is checked is used. In some instances, a user desires to make a group of edits to system data displayed in user interface 108 that are logically related. In some situations, it may be the case that when the user performs the edits in one particular sequence, each edit in the group, when sent to the database manager 104 as a proposed edit, would satisfy all associated rules applied during the rules checking process for that proposed edit. However, it may be the case that when the user performs the edits in a different sequence, one or more of the edits would fail one or more rules as a part of the rules checking process. This can occur even if the group of proposed edits would satisfy all applicable rules if the rules checking process were to be performed after all of the proposed edits had been applied to the system data stored in the system database 102.

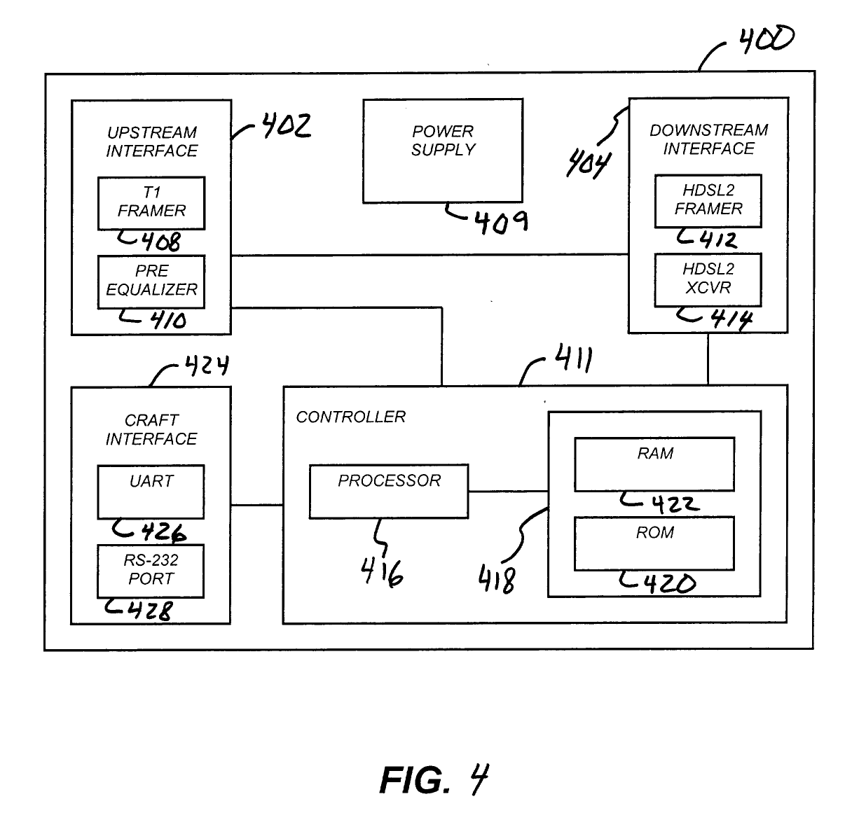

For example, in one embodiment, system database 102 stores system data related to the configuration of an HDSL2 line interface unit (for example, an HDSL2 line interface unit similar to the one shown in FIG. 4 below). Such a line interface unit can be configured to operate a number of E1 or V.35 communication channels or timeslots. In such an embodiment, one rule that is checked by the database manager 104 is, for example, that the maximum number of channels operated by the line interface unit (that is, the number of E1 channels plus the number V.35 channels) must be less than 32 (referred to here as the “maximum channel rule”). In this example, system data is stored in the system database 102 that indicates that the line interface unit is initially configured to operate 25 E1 channels and 5 V.35 channels. Then, a user may wish to reconfigure the line interface unit by first changing the number of V.35 channels operated by the line interface unit to 25 channels and then changing the number of E1 channels operated by the line interface unit to 5 channels.

In this example, the proposed changes, although acceptable when considered together, would not be allowed by the rules checker if corresponding edits were made in the order described above. This is because the maximum channel rule would not be satisfied by such a first proposed edit that would change the number of V.35 channels operated by the line interface unit from 5 channels to 25 channels. The number of E1 channels stored in the system database 102 plus the number of V.35 channels resulting from the proposed edit would result in a total number of channels equal to 50 channels, which is greater than 32. Thus, this proposed edit would not satisfy the maximum channel rule if applied first. If, however, the user first makes an edit that changes the number of E1 channels operated by the line interface unit from 25 channels to 5 channels and then makes a second edit that changes the number of V.35 channels operated by the line interface unit from 5 channels to 25 channels, each of the two proposed edits would pass the maximum channel rule in this sequence. Thus, the user must perform the edits in a particular sequence so that each successive edit will satisfy the rules checking process. This can be inconvenient for the user.

System 100 also includes a secondary database 114 in which edits are stored prior to submission to the database manager 104 for rules checking and, if appropriate, updating of system data stored in system database 102. In one embodiment, secondary database 114 is a database maintained locally by user interface manager 106. In other embodiments, secondary database 114 is located elsewhere in system 100. In one embodiment, in order to reduce complications relating to data transfer between the system database 102 and the secondary database 114, secondary database 114 is structurally the same as system database 102 but need not be as large as system database 102.

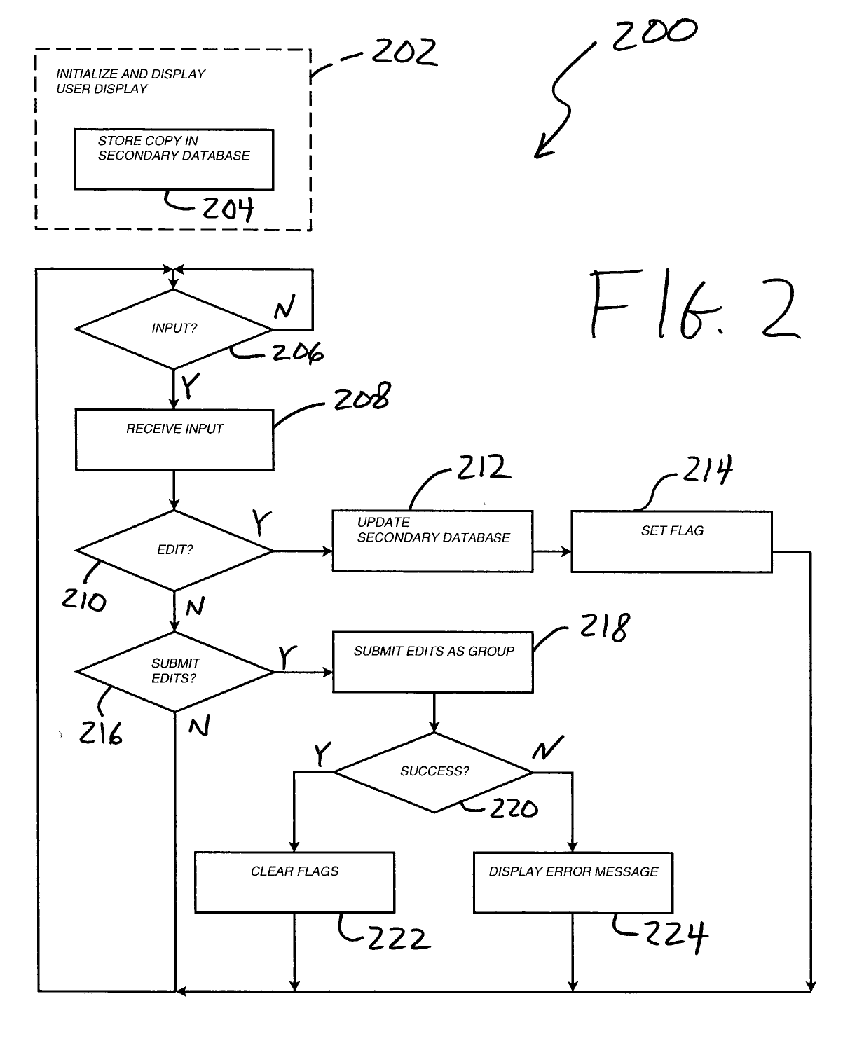

FIG. 2 is flow diagram of one embodiment of a method 200 of processing edits using secondary database 114. When the user interface 108 is first created and displayed (block 202), a copy of one or more item of system data displayed in the user interface 108 is stored in the secondary database 114 (block 204). In one embodiment, a copy of each item of system data displayed in the user interface 108 is stored in the secondary database 114 using the same type of data structure used to store the item in the system database 102. In other embodiments, a copy of each item of system data displayed in user interface 108 is stored secondary database 114 using data structures differing from the data structures used to store the system data in the system database 102 (for example, data structures that are optimized for retrieval speed, storage reduction, and/or similar implementation-specific considerations). Although, in the embodiment shown in FIG. 2, a copy of each item of system data displayed in the user interface 108 is stored in the secondary database 114, it is to be understood that more or less data is stored in secondary database 114 in other embodiments. For example, in other embodiments, copies of other system data is stored in the secondary database 114 even thought it is not displayed in user interface 108. Moreover, in other embodiments, copies for less than all of the items of system data displayed in the user interface 108 are stored in the secondary database 114.

Thereafter, when input is received from the user input device 108 (blocks 206 and 208), it is determined if the input indicates that an edit has been made to an item of system data displayed in the user interface 108 (block 210). When the input indicates that such an edit has been made, the copy of the edited item of system data stored in the secondary database 114 is updated based on the edit (block 212). For example, in one embodiment, a user uses conventional editing keystrokes to enter or change an item of system data displayed in a user interface component of user interface 108. When the user has completed such an edit, the user presses an arrow key or otherwise indicates that the focus of the user's input should be changed to a different user interface component of user interface 108. When this occurs, the edit is complete and the copy of that item of system data stored in the secondary database 114 is updated based on the edits (for example, in one implementation, the current value stored in the secondary database 114 for that item is replaced with an updated value reflecting the edit). In other embodiments, the copy of the edited item stored in the secondary database 114 is updated, for example, after each keystroke is received.

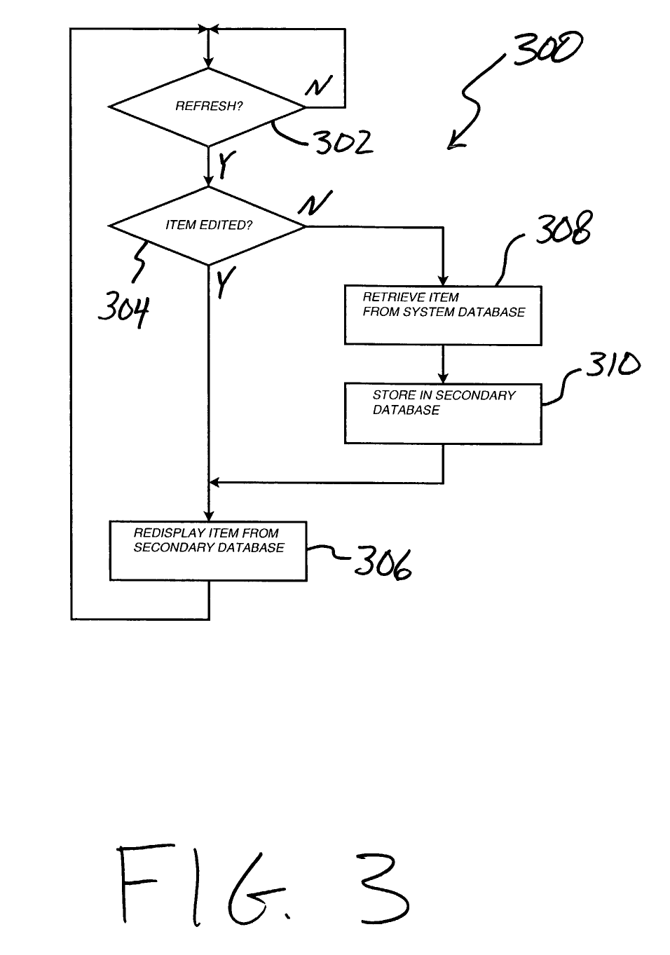

Method 200 also includes, in the embodiment shown in FIG. 2, setting a flag associated with the edited item (block 214). The flag indicates that the edited item of system data has been edited and that, as described below in connection with FIG. 3, the user interface component in which that item is displayed should be refreshed from the secondary database 114 instead of from the system database 102. It is to be understood, however, that in other embodiments, other mechanisms are used to determine if an edit has been made to an item of system data displayed in the user interface 108 (for example, by comparing the copy of the item stored in the secondary database 114 and with the system data stored in the system database 102). In one implementation, the flag is stored in the secondary database 114 along with the copy of the edited item.

Then, the input process is repeated to check for additional edits (returning to block 206). For each additional edit performed by the user, the copy of the edited item stored in the secondary database 114 is updated (block 212) and an associated flag is set (block 214), as described above. Multiple edits can be performed by the user for each field of the user interface 108 that is displayed.

Method 200 also determines if the input indicates that any previously received edits should be submitted to the database manager 104 for rules checking and, if appropriate, for updating the system database 102 (block 216). When the input indicates this, the edited items are submitted to the database manager 104 for rules checking as a group (block 218). For example, in one embodiment, when the input indicates that the user has pressed the “Enter” key, the flag associated with each item stored in the secondary database 114 is checked. If an item's flag is set (that is, if the item has been edited), the copy of that item stored in the secondary database 114 is retrieved. Then, all of the edited items retrieved from the secondary database 114 are submitted to the database manager 104 for rules checking and, if appropriate, updating the system data stored in the system database 102. In other embodiments, other input indicates that the edits should be submitted to the database manager for rules checking.

In the embodiment shown in FIG. 2, if the group of edits successfully pass the rules checking process (checked in block 220), all the flags associated with the items stored in system database 114 are cleared (block 222). If the group of edits does not successfully pass the rules checking process, then a message is displayed for the user (block 224) and the user is allowed to make further edits. In this way, a user can make multiple edits and submit the edits to the database manager 104 for rules checking as a group. This allows the user to enter a set of edits in any sequence and then submit the set of edits as a group for rules checking. This can make the entry of a set of edits more convenient for the user.

FIG. 3 is one embodiment of a method 300 of refreshing an item of system data displayed in a user interface 108. Method 300 includes determining if the item of system data should be refreshed (block 302). For example, in one embodiment, each item of system displayed in a user interface component of user interface 108 is periodically refreshed. If the item of system data is to be refreshed, it is determined if the item has been edited (block 304). For example, in one embodiment, whether or not an item has been edited is determined by checking if a flag associated with that item has been set. If the item has been edited, the item is refreshed by redisplaying the item using the copy of the item stored in the secondary database 114 (block 306).

In the embodiment shown in FIG. 3, if the item has not been edited, the current value for the item of system data stored in the system database 102 is retrieved from the system database 102 (block 308) and stored in the secondary database 114 (block 310). For example, in one embodiment, the current value for the item to be refreshed is requested from the database manager 104. The database manager 104 retrieves the item of system data from the system database 102 and passes it to the user interface manager 106. The user interface manager 106 then replaces the copy of the item stored in the secondary database 114 with the retrieved item. Then, in the embodiment shown in FIG. 3, the item is refreshed by redisplaying the item using the copy of the item stored in the secondary database 114 (block 306).

As a result, items displayed in the user interface 108 that have not been edited by the user are refreshed with the most recent system data stored in the system database 102 for those items. This allows the user to see the most recent data for any unedited items. Items displayed in the user interface display 108 that have been edited by the user are refreshed by redisplaying the items stored in the secondary database 114. That is, user interface 108 will show all edits made by the user.

The systems and methods described here can be implemented by programming a programmable processor with program instructions that cause the programmable processor (or a device in communication with the programmable processor) to carry out the described processing or functionality. FIG. 4 is a block diagram of one embodiment of an HDSL line interface unit (also referred to here as a “line interface card” or “line card”) 400 that can be used to implement the system and methods described here. Line interface unit 400 is used to send and receive DS1 traffic over an HDSL2 communication link using a single twisted-pair telephone line. The line interface unit 400 includes an upstream interface 402 and a downstream interface 404. Upstream interface 402 and downstream interface 404 couple the line interface unit 400 to an upstream link and a downstream link, respectively. In the embodiment shown in FIG. 4, the upstream link is a DSX-1 link that is cross-connected to a time division-multiplexing network. The upstream interface 402 couples the line interface unit 400 to the DSX-1 link and includes, for example, a T1 framer 408 and a DSX-1 pre-equalizer 410. The downstream link is an HDSL2 link. The downstream interface 404 couples the line interface unit 400 to the HDSL2 link and includes, for example, an HDSL2 framer 412 and an HDSL2 transceiver 414.

The line interface unit 400 includes a power supply 409 for providing power to the components of the line interface unit 400. The line interface unit 400 also includes control logic 411. Control logic 411 includes a programmable processor 416 and a memory 418. Memory 418 includes both read-only memory (“ROM”) 420 and random access memory (“RAM”) 422. In addition, the line interface unit 400 includes a craft interface 424. Craft interface 424 includes, for example, a universal asynchronous receiver-transmitter (“UART”) 426 that couples an RS-232 serial port 428 to the processor 416.

A user can connect a portable computer or other data terminal to the serial port 428 and communicate with an embedded control program executing on the programmable processor 416. In one embodiment, the embedded control program allows the user to view and change system settings and view system performance, history, alarm, and inventory data. Alternatively, the user can communicate with the embedded control program over an embedded operations channel carried among the DS1 traffic handled by the line interface unit 400. Although FIG. 4 depicts an HDSL2 line interface unit, other telecommunication devices can be used to implement the techniques described here. For example, G.SHDSL, HDSL, HDSL4, asynchronous digital subscriber line (ADSL), plain old telephone service (POTS), integrated services digital network (ISDN), and cable-modem line interface cards can be used.

The system 100 described above in connection with FIG. 1, and methods 200 and 300 described above in connection with FIGS. 2 and 3, respectively, are implemented, in one embodiment, by programming the programmable processor 416 with appropriate program instructions. Appropriate program instructions and data structures are stored, for example, in memory 418. In other implementations, one or more portions of the system 100 are implemented and executed on devices (such as an element or network manager system) that are in communication with the line interface unit 400. Such an embodiment allows a user of the line interface unit 400 to reconfigure the line interface unit 400 in a convenient manner by entering a set of edits using user interface in any order. The set of edits can then be submitted as a group for rules checking and, if appropriate, storage in a system database

The methods and techniques described here may be implemented in digital electronic circuitry, or with a programmable processor (for example, a special-purpose processor or a general-purpose process such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method of processing edits to one or more of a plurality of items stored in a first database, comprising:
receiving input;
when the input indicates that an edit has been made to one of the plurality of items, storing the edited item in a second database, wherein the second database stores a set of edited items; and
when the input indicates that the set of edited items should be stored in the first database, retrieving the set of edited items from the second database and submitting the set of edited items for rules checking as a group.

2. The method of claim 1, further comprising, when the input indicates that the edit has been made to the one of the plurality of items, setting a flag associated with the edited item, wherein the flag indicates that the edited item has been edited.

3. The method of claim 1, further comprising displaying the plurality of items in a user interface.

4. The method of claim 3, wherein each of the plurality of items is displayed in a user interface component included in the user interface.

5. The method of claim 1, wherein the first database is a system database and the plurality of items relate to a line interface unit.

6. The method of claim 1, wherein the rules checking includes determining if a rule associated with a member of the set of edited items is satisfied.

7. A program comprising a storage medium tangibly embodying program instructions for processing edits to one or more of a plurality of items stored in a first database, the program instructions including instructions operable to cause at least one programmable processor to:
receive input;
when the input indicates that an edit has been made to one of the plurality of items, store the edited item in a second database, wherein the second database stores a set of edited items; and
when the input indicates that the set of edited items should be stored in the first database, retrieve the set of edited items from the second database and submit the set of edited items for rules checking as a group.

8. The program of claim 7, wherein the program instructions further include instructions operable to cause the at least one programmable processor to, when the input indicates that the edit has been made to the one of the plurality of items, set a flag associated with the edited item, wherein the flag indicates that the edited item has been edited.

9. The program of claim 7, wherein the program instructions further include instructions operable to cause the at least one programmable processor to display the plurality of items in a user interface.

10. The program of claim 9, wherein each of the plurality of items is displayed in a user interface component included in the user interface.

11. The program of claim 7, wherein the first database is a system database and the plurality of items relate to a line interface unit.

12. The program of claim 7, wherein the rules checking includes determining if a rule associated with a member of the set of edited items is satisfied.

13. A telecommunication device, comprising:
a first interface adapted to couple the telecommunications device to a user input device; and
a controller, coupled to the first interface, adapted to:
receive input from the input device;
when the input indicates that an edit has been made to one of the plurality of items, store the edited item in a second database, wherein the second database stores a set of edited items; and
when the input indicates that the set of edited items should be stored in the first database, retrieve the set of edited items from the second database and submit the set of edited items for rules checking as a group.

14. The telecommunication device of claim 13, further comprising:
a second interface adapted to couple the telecommunications device to a first communication link; and
a third interface adapted to couple the telecommunications device to a second communication link.

15. The telecommunication device of claim 14, wherein the telecommunications device is an HDSL line interface unit.

16. The telecommunication device of claim 15, wherein the first communication link is a DSX-1 communication link and the second communication link is an HDSL link.

17. The telecommunication device of claim 16, wherein the second interface includes a T1 framer and a DSX-1 pre-equalizer.

18. The telecommunication device of claim 16, wherein the third interface includes an HDSL2 framer and an HDSL2 transceiver.

19. The telecommunication device of claim 13, wherein the controller includes a programmable processor coupled to the first interface and a memory coupled to the programmable processor, wherein program instructions are stored in the memory that are operable to cause the programmable processor to:
receive input from the input device;
when the input indicates that the edit has been made to one of the plurality of items, store the edited item in the second database; and
when the input indicates that the set of edited items should be stored in the first database, retrieve the set of edited items from the second database and submit the set of edited items for rules checking as the group.

20. The telecommunication device of claim 13, wherein the controller is further adapted to, when the input indicates that the edit has been made to the one of the plurality of items, set a flag associated with the edited item, wherein the flag indicates that the edited item has been edited.

21. The telecommunication device of claim 13, wherein the controller is further adapted to display the plurality of items in a user interface.

22. The telecommunication device of claim 21, wherein each of the plurality of items is displayed in a user interface component included in the user interface.

23. The telecommunication device of claim 13, wherein the first database is a system database and the plurality of items relate to a line interface unit.

24. The telecommunication device of claim 13, wherein the rules checking includes determining if a rule associated with a member of the set of edited items is satisfied.

25. A method of refreshing an item displayed in a user interface, comprising:
determining when the item has been edited;
when the item has not been edited, displaying the value for the item stored in a first database; and
when the item has been edited, displaying the edited value for the item stored in a second database.

26. The method of claim 25, wherein, when the item has not been edited, displaying the item retrieved from the first database includes storing the retrieved item in the second database, retrieving the item from the second database, and displaying the item retrieved from the first database.

27. The method of claim 25, wherein determining when the item has been edited includes determining when a flag associated with the item has been set.

28. A program comprising a storage medium tangibly embodying program instructions for refreshing an item displayed in a user interface, the program instructions including instructions operable to cause at least one programmable processor to:
determine when the item has been edited;
when the item has not been edited, display the value for the item stored in a first database; and
when the item has been edited, display the edited value for the item stored in a second database.

29. The program of claim 28, wherein the program instructions further include instructions operable to cause the programmable process to, when the item has not been edited, store the retrieved item in the second database, retrieve the item from the second database, and display the item retrieved from the first database.

30. The program of claim 28, wherein the program instructions further include instructions operable to cause the programmable process to determine when a flag associated with the item has been set.

31. A telecommunication device, comprising:
a first interface adapted to couple the telecommunications device to an output device; and
a controller, coupled to the first interface, adapted to:
determine when an item displayed in a user interface on the output device has been edited;
when the item has not been edited, display in the user interface on the output device the value for the item stored in a first database; and
when the item has been edited, display in the user interface on the output device the edited value for the item stored in a second database.

32. The telecommunication device of claim 31, further comprising:
a second interface adapted to couple the telecommunications device to a first communication link; and
a third interface adapted to couple the telecommunications device to a second communication link.

33. The telecommunication device of claim 32, wherein the telecommunications device is an HDSL line interface unit.

34. The telecommunication device of claim 33, wherein the first communication link is a DSX-1 communication link and the second communication link is an HDSL link.

35. The telecommunication device of claim 34, wherein the second interface includes a T1 framer and a DSX-1 pre-equalizer.

36. The telecommunication device of claim 34, wherein the third interface includes an HDSL2 framer and an HDSL2 transceiver.

37. The telecommunication device of claim 34, wherein the controller includes a programmable processor coupled to the first interface and a memory coupled to the programmable processor, wherein program instructions are stored in the memory that are operable to cause the programmable processor to:
determine when the item displayed in the user interface on the output device has been edited;
when the item has not been edited, display in the user interface on the output device the value for the item stored in a first database; and
when the item has been edited, display in the user interface on the output device the edited value for the item stored in the second database.

38. The telecommunication device of claim 34, wherein the controller is further adapted to, when the item has not been edited, store the retrieved item in the second database, retrieve the item from the second database, and display the item retrieved from the first database.

39. The telecommunication device of claim 34, wherein the controller is further adapted to determine when a flag associated with the item has been set.
